(19) United States
(12) Patent Application Publication
(10) Pub. No.: US 2018/0107761 A1
(43) Pub. Date: Apr. 19, 2018

(54) GUIDING USERS IN INFORMATION EXTRACTION USING QUERY SUGGESTIONS

(71) Applicant: Linguamatics Ltd., Cambridge (GB)

(72) Inventors: David Richard Milward, Cambridge (GB); Paul Barry Milligan, Cambridge (GB); Ian Lewin, Cambridge (GB); Roger Charles Attrill, Little Thetford (GB)

(21) Appl. No.: 15/785,249

(22) Filed: Oct. 16, 2017

Related U.S. Application Data
(60) Provisional application No. 62/408,941, filed on Oct. 17, 2016.

(51) Int. Cl. G06F 17/30

(52) U.S. Cl. CPC G06F 17/30973; G06F 17/3053

(57) ABSTRACT

Key information is locked within unstructured or semi-structured electronic documents or structured databases. Current user interfaces are either designed for information professionals and require training and high skill levels, or provide access to single structured data sources. Query suggestion technology provides a way that occasional users can get high value from unstructured or semi-structured data or heterogeneous structured data, or a combination of unstructured or semi-structured and structured data. In contrast to search technology, the user obtains structured results, that can be manipulated similar to spreadsheets, or via interactive visualization. Queries suggestions are ranked based on the terms or concepts entered by the user in addition to standard ranking methods such as ranking by frequency of usage.

### CROSS-REFERENCE TO RELATED APPLICATIONS

The present application claims the benefit of U.S. Provisional Application Ser. No. 62/408,941, entitled “GUIDING USERS IN INFORMATION EXTRACTION USING QUERY SUGGESTIONS,” filed on Oct. 17, 2016, and which is incorporated by reference in its entirety herein.

### BACKGROUND

Key information is locked within unstructured or semi-structured electronic documents or structured databases. User interfaces are either designed for information professionals and require training and high skill levels, or provide access to single structured data sources. There is a need for simpler interfaces that can be used by occasional users, but still allow access to either unstructured or semi-structured data, to heterogeneous structured data, or to unstructured, semi-structured and structured data.

### BRIEF DESCRIPTION OF THE DRAWINGS

Embodiments of the present technology will be described and explained through the use of the accompanying drawings in which:

FIG. 1 is a user interaction diagram illustrating the choices a user makes as they are guided to a suitable query strategy, as enabled by some implementations of the presently disclosed technology.

FIGS. 2A-2L provide examples of screenshots showing a possible interaction of a user with a query suggestion system, starting by selecting a source, then entering a term of interest, and finishing by running a query to obtain results.

FIG. 3 is a schematic illustration of the process of query matching.

FIG. 4 illustrates an example of an operating environment in which some embodiments of the present technology may be utilized.

FIG. 5 is a block diagram illustrating an example machine representing the computer systemization of the query platform.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure or characteristic described in connection with the embodiment is included in at least one embodiment of the disclosure. The various appearances of the phrase “in one embodiment” in the specification do not necessarily refer to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

The terms used in this specification generally have their ordinary meanings in the art, within the context of the disclosure, and in the specific context in which each term is used. Certain terms that are used to describe the disclosure are discussed below, or elsewhere in the specification, to provide additional guidance to the practitioner regarding the description of the disclosure. Certain terms may be highlighted, for example, by using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein; no special significance is to be placed on whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for the convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in the broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description.

Various embodiments of the present technology generally relate to query suggestion technology. More specifically, some embodiments of the query suggestion technology disclosed herein can provide a method of extracting information from unstructured text, semi-structured text or structured data or any combination of the three forms.

Current search technology can be used but the results are documents. Embodiments of the present technology allow results in a tabular format, directly answering questions.

As described in greater detail below, some embodiments of the query suggestion technology can overcome the challenge of making extraction technology accessible to non-specialists by providing intelligent suggestions based on the information the user provides. The suggestions may be dynamically presented in response to interactions from a user. These interactions from the user in response to suggestions from the query suggestion technology can be used to guide the user through a process to effortlessly build a sophisticated query. Upon completion, the query can be used to retrieve a set of relevant results which can be presented to the user in a variety of ways.

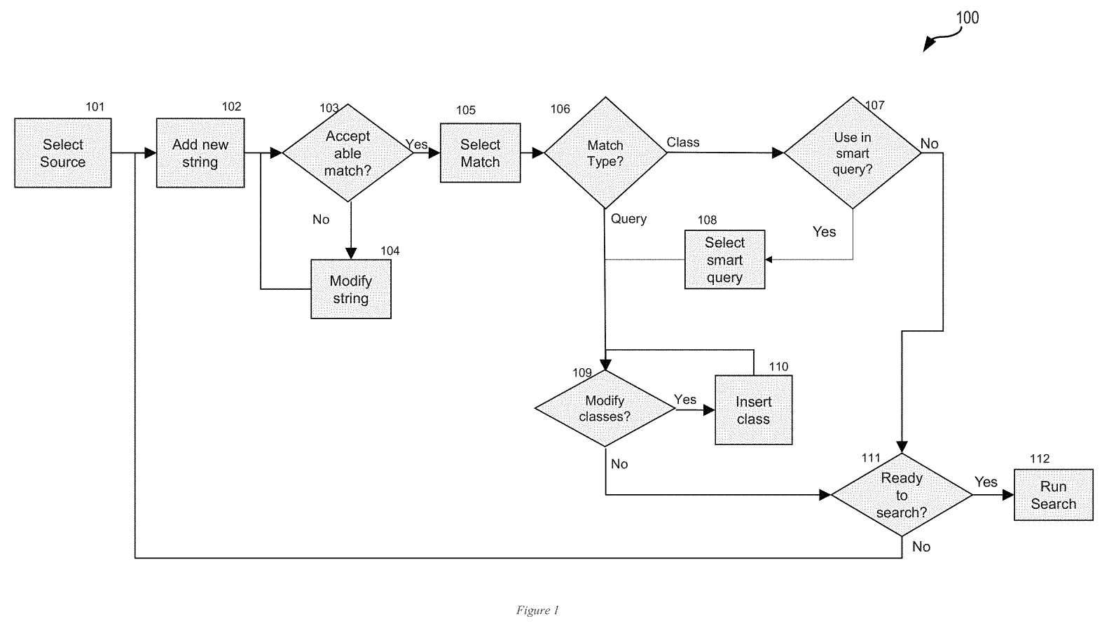

FIG. 1 is a flow diagram illustrating a process 100 used in some embodiments for providing query suggestions to extract information from unstructured text, semi-structured or structured data. Unstructured text may contain a statement such as “profit in 2015 for Company A was 2 million dollars.” Examples of unstructured text include documents in formats such as Word or WordPerfect. Examples of semi-structured data include documents in formats such as HTML or XML, which identify (a) sections such as title, abstract and conclusion which themselves contain unstructured text, and/or (b) some structure for tables which may not provide meaningful relationships between table cells and their respective row and column headers. Examples of structured data include data found in an SQL database or in a semantic web store.

In the embodiments illustrated in FIG. 1, at stage 101, a particular data source can be chosen. The data source may be local, remote, or cloud-based. Examples may include specific scientific or medical databases or any other type of data source (e.g., sports, news, geographic-based data sources, etc.) that provides information which a user may desire to search. Alternative implementations might not include this step for selecting an available data source. In those embodiments, for example, all data sources could be selected and used as appropriate for particular queries.

At stage 102 the user types characters or speaks one or more words. This may be done through a user interface that may be accessed via a mobile application, web-based access portal, or other thick or thin client. As these characters are processed, the query technology can begin to predict completion strings and/or relevant suggestions. This may be based on local or global user profiles or other types of information available to the query technology.

At stage 103 the user can be presented with one or more predicted matches that are potentially appropriate responses for the current context. The context may be characters typed in stage 102, or include other items such as classes, verbatim terms or queries that result from stage 111 in earlier iterations.

Each match can be either a class, a query or the verbatim term. The matches are ranked to provide the most relevant class or query matches. Classes refer to concepts however the concept might be expressed in text. Classes may have family relationships such as one class being a child of another class. In one embodiment classes are created using terminologies which define synonyms and hypernyms or hyponyms. An example class might be a specific drug such as “Cyclosporine” which could be referred to as “cyclosporine”, “ciclosporin” or “CSA”, or a class of drugs such as “Immunosuppressants”.

Queries are executable procedures which may extract specific pieces of information in the data source for direct presentation to the user or for further processing as decided by the user. Queries, in some embodiments, could be defined in terms of words, classes, word distance, linguistic constructions, or regions or fields of a semi-structured or structured data source. Parts of queries could be explicitly parameterized so that other terms can be substituted in, for example, a specific disease term rather than a generic disease. An example query might find treatment relationships between a compound and a disease, or find typical dosages of a compound. In some embodiments queries can be defined using a query language or using a graphical user interface.

The verbatim term is a direct copy of the characters entered in stage 102 and may be used if there are no other results.

A match that is a class is the result of a process of class matching. Class matching compares information in the characters typed to information in known classes. For example, the characters typed may be identical to the name of a class or identical to the name of a synonym associated with that class or identical to some other datum otherwise associated with that class. The characters typed may be a substring of the name of a class or a substring of a synonym or a substring of some other datum otherwise associated with that class. The above use of “identical to” and “a substring of” is purely illustrative and does not limit the possible comparisons that may be carried out.

A match that is a query is the result of a process of query matching. Query matching compares information in the characters typed to information in known queries, taking into account other classes already present in the search (if any) as a result of stage 111 in earlier iterations. For example, the characters typed may be identical to, or a substring of, or resemble in some other way, the name of a query, its description or any other datum associated to that query.

Smart query matching compares one or more classes selected by the user to a set of specific data items in the query called its slots. The slots of a query are parameters or variables of that query. For example, a query that searches for things of type A that cause things of type B may have two parameters: the types A and B. If type A is GENE and type B is DISEASE then the query searches for genes that cause diseases. If type A is ONCOGENE and type B is DISEASE then the query searches for oncogenes that cause diseases. Each slot in a query can be described by a term called its semantic category, for example GENE, DISEASE and ONCOGENE. Similarly, each class can also described by a semantic category. Semantic categories can be compared using a relation of information containment or subsumption.

For example, the category GENE subsumes the category ONCOGENE because every oncogene is, by definition, a gene. Two semantic categories are consistent if there is some category which they both subsume. For example, the category GENE is consistent with the category ONCOGENE because they both subsume the category ONCOGENE. In some embodiments, a class could be assigned to a query slot if the semantic category of the class is subsumed by the semantic category of the slot. In other embodiments, this might be generalized so that a class could be assigned to a query slot if the semantic category of the class is consistent with the semantic category of the slot.

A class matches a query if the class can be assigned to at least one slot of the query. When multiple classes match a query, in some embodiments, every class must be assigned to a different slot; in some embodiments, every class must be assigned to some specific slot; in some embodiments, not every class needs to be assigned but the suggestions are ranked according to how many classes are assigned (e.g., a higher ranking when more classes are assigned).

In one illustrative implementation, the set of semantic categories contains four categories: GENE, DISEASE, CHEMICAL and ENTITY. The category ENTITY subsumes each of the other three categories. The other three categories do not subsume any other category. That is, genes, diseases and chemicals are all entities. Genes are not diseases or chemicals. Diseases are not genes or chemicals. Chemicals are not genes or diseases. In these embodiments, a class such as Psoriasis may be described by the category DISEASE. This class can be assigned to a query slot which is also described by the category DISEASE because the two terms DISEASE and DISEASE are consistent. Similarly, the Psoriasis class can be assigned to a slot described by the category ENTITY. In other implementations the semantic categories might be finer-grained, or semantic categories would correspond directly to classes, so that psoriasis would be assigned the semantic category PSORIASIS which would be subsumed by both DISEASE and ENTITY.

In one embodiment, the matches that are presented to the user in stage 103 are rank ordered according to a preference scheme. The preference scheme may take account of information associated with the classes and queries presented. The preference scheme may take account of the order in which terms are added to a query through iterations of the process shown in FIG. 1. The preference scheme may take account of stored information about the user and previous choices the user has made. The preference scheme may take account of stored information about choices other users have made.

At stage 103, the user can choose to accept one of matches or reject the matches.

At stage 104 the user will modify the characters by deleting all or part of the original string and then typing new characters. Modifying the string will trigger new matches to be presented to the user.

At stage 105 the user selects a match. The user may also select a set of matches. In the latter case, the set of matches are considered to be a list of alternative items for the search. In case the user selects the verbatim term, this is considered to be similar to a class in the following stages.

If, at stage 105, the user selects a class, the user may be presented with further matches, these being queries which are appropriate for the selected class. That is, the queries presented will also match one or more of the set of classes consisting of the class selected in stage 105 together with any classes selected as a result of stage 111 through the process of smart query matching described above. If a verbatim term was selected at stage 105, then the verbatim term is considered to be compatible with all queries.

At stage 107 the user may decide to use the class by itself or in the context of a query which is one of the matches presented following stage 105.

At stage 108 the user selects a query from the matches presented following stage 105. This query is now part of the search. If the query contains terms that can be modified, these are presented to the user. The user may repeat this stage at will if they wish to update the query. If a query contains items modified in stage 110, the results presented will be compatible with these items.

At stage 109 the user may decide to alter the query by modifying the terms that the query contains, if the query does contain terms that may be modified. This stage may be repeated if the query contains multiple terms that may be modified.

At stage 110 the user can update the terms in the query by selecting a class or a verbatim item to insert into the query. The choice of class will depend upon characters typed by the user as well as the query: the class should be compatible with the query, although a verbatim item is considered to be compatible with all queries. The user may repeat this stage at will if they wish to update the terms in the query. It is also possible to select a group of items, which would be considered as alternative items in the search.

At stage 111 the user considers whether the search is ready for submission. If the search is not ready for submission, the user may freely delete classes and queries in the search and re-enter process 100 at the appropriate point or the user may add more classes and queries to the search starting from stage 102.

At stage 112 the user has considered that the search is ready and has indicated that it should be submitted. This submission could be triggered by a button press, a key command or voice control. In some embodiments the query is executed against an index built from the source documents. In some embodiments the query is executed against the documents directly.

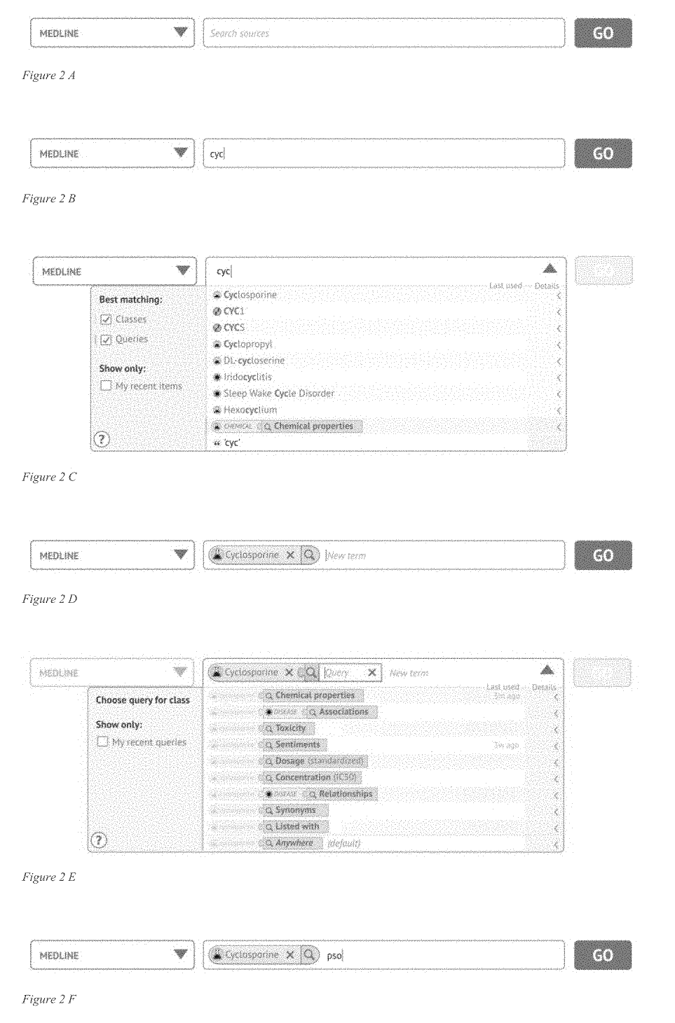

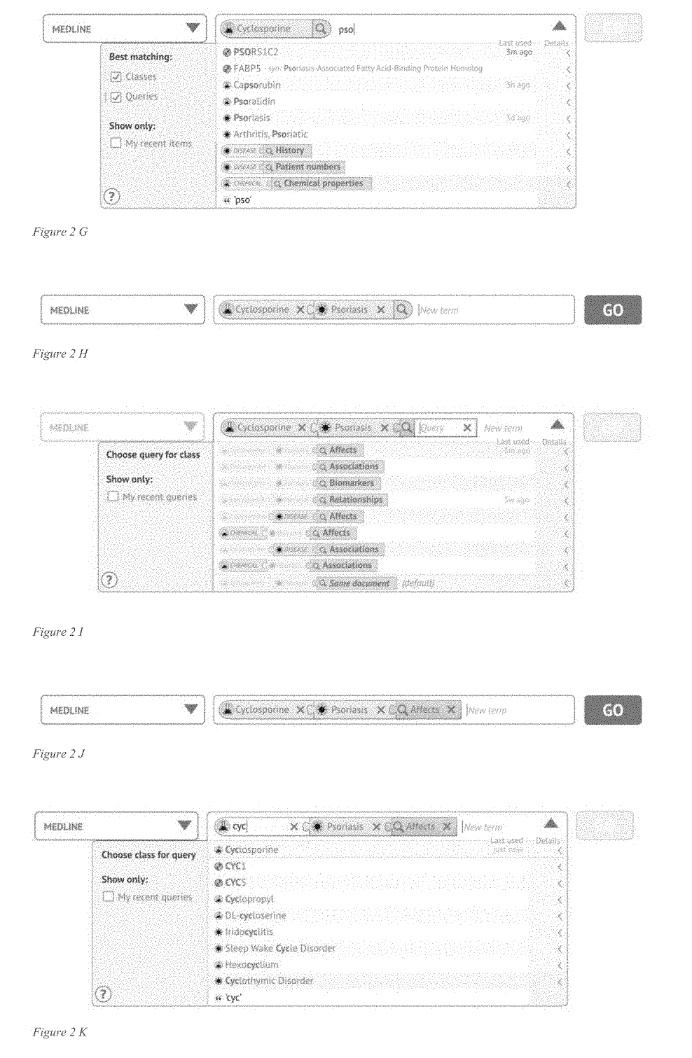

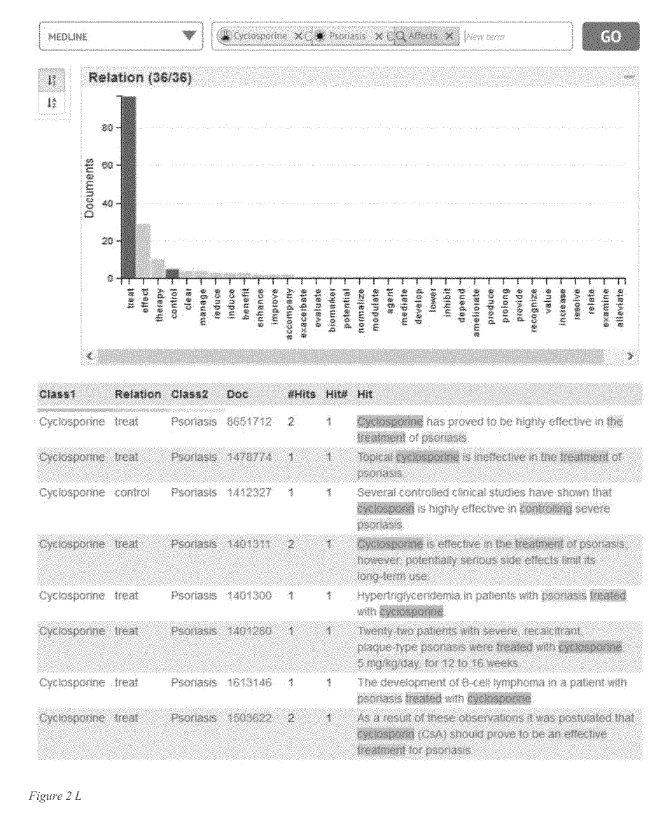

FIG. 2A is an example screenshot showing the stage after the user has selected a source (FIG. 1 stage [101]).

FIG. 2B is an example screenshot showing the stage after the user has added one new string (FIG. 1 stage [102]).

FIG. 2C is an example screenshot showing the stage when matching items are suggested to the user for the first new string (FIG. 1 stage [103]).

FIG. 2D is an example screenshot showing the stage after the user has selected an acceptable class (FIG. 1 stage [105]). In this case the user has chosen the chemical concept “Cyclosporine”.

FIG. 2E is an example screenshot showing the stage after a class has been inserted and matching queries are being suggested to the user (FIG. 1 stage [107]). Query ranking is affected by how well the queries match the current user input. In this case, “Cyclosporine” is a type of chemical which leads to queries being suggested that provide information about chemicals or relate chemicals to other concepts such as concentrations or diseases.

FIG. 2F is an example screenshot showing the stage after the user has inserted one class and added another new string (FIG. 1 stage [102]).

FIG. 2G is an example screenshot showing the stage when matching items are suggested to the user for the second new string (FIG. 1 stage [103]).

FIG. 2H is an example screenshot showing the stage after the user has selected a second acceptable class (FIG. 1 stage [105]).

FIG. 2I is an example screenshot showing the stage after a second class has been inserted and matching queries are being suggested to the user (FIG. 1 stage [107]). Query ranking is affected by how well the queries match the current user input. In this case, “Cyclosporine” is a type of chemical and “Psoriasis” is a type of disease which leads to queries being suggested that relate chemicals to diseases.

FIG. 2J is an example screenshot showing the stage after the user has selected an acceptable query (FIG. 1 stage [108]).

FIG. 2K is an example screenshot showing the stage while a class is being modified and matching classes are being suggested to the user (FIG. 1 stage [109]).

FIG. 2L is a an example screenshot showing the stage after the user has completed their query and has submitted it (FIG. 1 stage [112]).

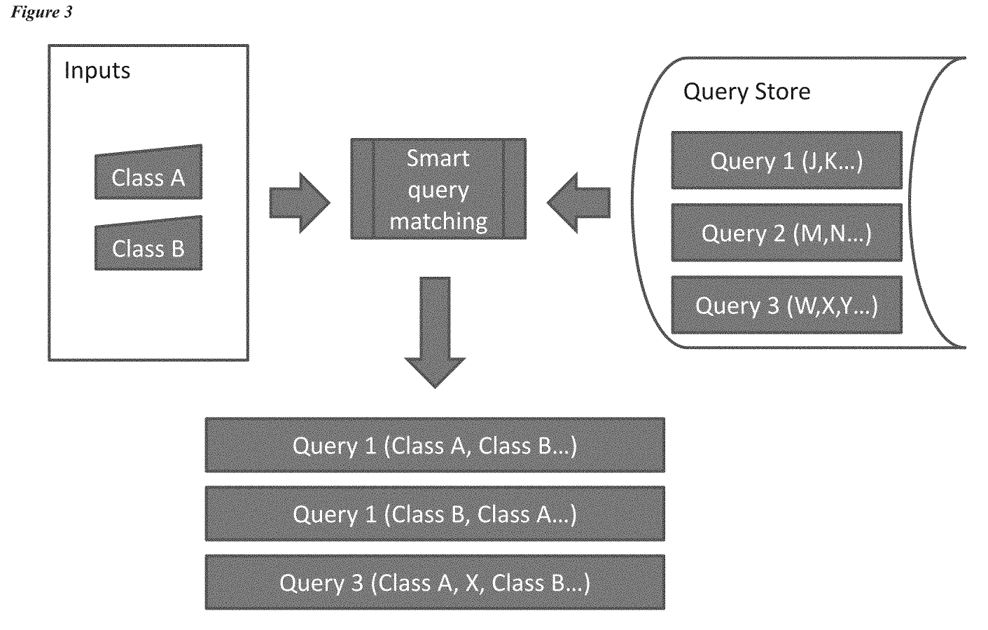

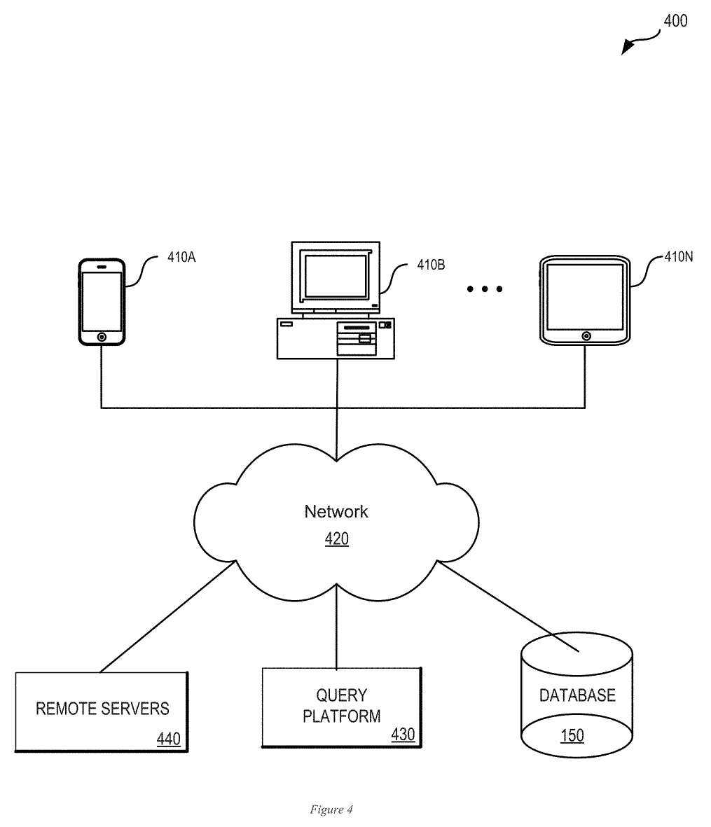

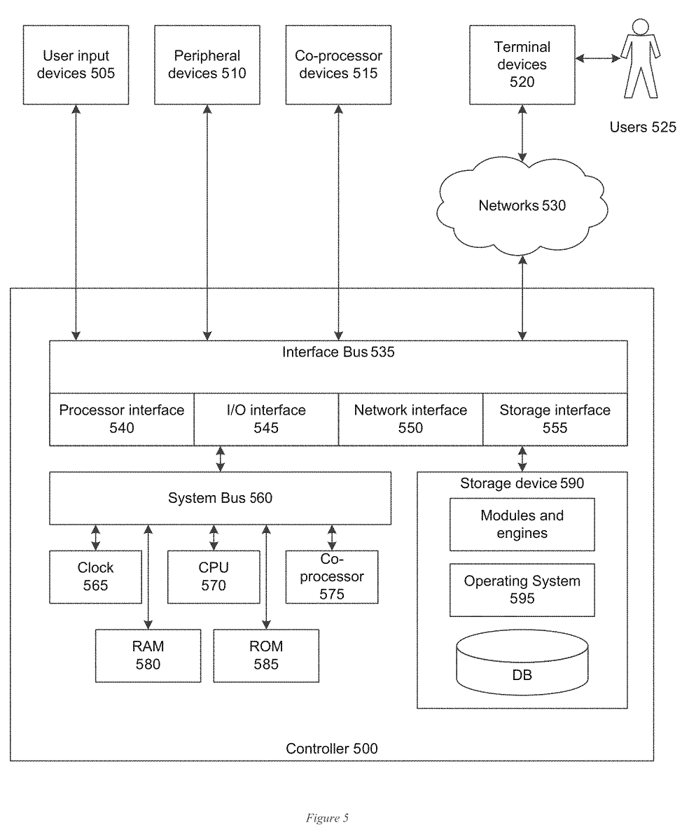

FIG. 3 is a schematic illustration of an example of the process of smart query matching. The input to the process in this example consists of a set of two classes: Class A and Class B. In this illustration, suppose that Class A results from stage 111 in one iteration of the process in FIG. 1 and Class B results from stage 105 in a second iteration. There are three stored queries: Q1, Q2 and Q2, each of which possesses at least 2 slots. Two slots of Q1 are labelled J and K. Two slots of Q2 are labelled M and N. Three slots of Q3 are labelled W, X and Y. Three smart query matches are depicted. In the first, class A is assigned to slot J of Q1 and class B is assigned to slot K of Q1. That is, the semantic category of class A has been determined to be consistent with the semantic category of slot J of Q1 and the semantic category of class B has been determined to be consistent with the semantic category of slot K of Q1. The other outputs of the smart query matching may be described similarly: in the second case, class A is assigned to slot K of Q1 and class B is assigned to slot J of Q1; in the third, class A is assigned to slot W of Q3, class B is assigned to slot Y of Q3 and no class is assigned to slot X of Q3.

FIG. 4 illustrates an example of an operating environment 400 in which some embodiments of the present technology may be utilized. As illustrated in FIG. 4, operating environment 400 may include one or more computing devices 410A-410N (such as a mobile phone, tablet computer, mobile media device, mobile gaming device, vehicle-based computer, wearable computing device, etc.), communications network 420, remote servers 430A-430N, query platform 440, and database 450.

Computing devices 410A-410N can include network communication components that enable the mobile devices to communicate with remote servers 430A-430N or other portable electronic devices by transmitting and receiving wireless signals using licensed, semi-licensed or unlicensed spectrum over communications network 420. In some cases, communication network 420 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. Communications network 420 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

Those skilled in the art will appreciate that various other components (not shown) may be included in computing devices 410A-410N to enable network communication. For example, a computing device may be configured to communicate over a GSM mobile telecommunications network. As a result, the mobile device may include a Subscriber Identity Module (SIM) card that stores an International Mobile Subscriber Identity (IMSI) number that is used to identify the mobile device on the GSM mobile communications network or other networks, for example, those employing 3G and/or 4G wireless protocols. If the mobile device is configured to communicate over another communications network, the mobile device may include other components that enable it to be identified on the other communications networks.

In some embodiments, computing devices 410A-410N may include components that enable them to connect to a communications network using Generic Access Network (GAN) or Unlicensed Mobile Access (UMA) standards and protocols. For example, a mobile device may include components that support Internet Protocol (IP)-based communication over a Wireless Local Area Network (WLAN) and components that enable communication with the telecommunications network over the IP-based WLAN. Mobile devices 410A-410N may include one or more mobile applications that need to transfer data or check-in with remote servers 430A-430N, query platform 440, and/or databases 450 for running searches.

### Exemplary Computer System Overview

Aspects and implementations of the query system of the disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

FIG. 5 is a block diagram illustrating an example machine representing the computer systemization of the query system. The query system controller 500 may be in communication with entities including one or more users 525 client/terminal devices 520 (e.g., devices 410A-410N), user input devices 505, peripheral devices 510, an optional co-processor device(s) (e.g., cryptographic processor devices) 515, and networks 530 (e.g., 420 in FIG. 4). Users may engage with the controller 500 via terminal devices 520 over networks 530.

Computers may employ central processing unit (CPU) or processor to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The controller 500 may include clock 565, CPU 570, memory such as read only memory (ROM) 585 and random access memory (RAM) 580 and co-processor 575 among others. These controller components may be connected to a system bus 560, and through the system bus 560 to an interface bus 535. Further, user input devices 505, peripheral devices 510, co-processor devices 515, and the like, may be connected through the interface bus 535 to the system bus 560. The interface bus 535 may be connected to a number of interface adapters such as processor interface 540, input output interfaces (I/O) 545, network interfaces 550, storage interfaces 555, and the like.

Processor interface 540 may facilitate communication between co-processor devices 515 and co-processor 575. In one implementation, processor interface 540 may expedite encryption and decryption of requests or data. Input output interfaces (I/O) 545 facilitate communication between user input devices 505, peripheral devices 510, co-processor devices 515, and/or the like and components of the controller 500 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 550 may be in communication with the network 530. Through the network 530, the controller 500 may be accessible to remote terminal devices 520. Network interfaces 550 may use various wired and wireless connection protocols such as, direct connect, Ethernet, wireless connection such as IEEE 802.11a-x, and the like.

Examples of network 530 include the Internet, Local Area Network (LAN), Metropolitan Area Network (MAN), a Wide Area Network (WAN), wireless network (e.g., using Wireless Application Protocol WAP), a secured custom connection, and the like. The network interfaces 550 can include a firewall which can, in some aspects, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 555 may be in communication with a number of storage devices such as, storage devices 590, removable disc devices, and the like. The storage interfaces 555 may use various connection protocols such as Serial Advanced Technology Attachment (SATA), IEEE 1394, Ethernet, Universal Serial Bus (USB), and the like.

User input devices 505 and peripheral devices 510 may be connected to I/O interface 545 and potentially other interfaces, buses and/or components. User input devices 505 may include card readers, finger print readers, joysticks, keyboards, microphones, mouse, remote controls, retina readers, touch screens, sensors, and/or the like. Peripheral devices 510 may include antenna, audio devices (e.g., microphone, speakers, etc.), cameras, external processors, communication devices, radio frequency identifiers (RFIDs), scanners, printers, storage devices, transceivers, and/or the like. Co-processor devices 515 may be connected to the controller 500 through interface bus 535, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The controller 500 may employ various forms of memory including on-chip CPU memory (e.g., registers), RAM 580, ROM 585, and storage devices 590. Storage devices 590 may employ any number of tangible, non-transitory storage devices or systems such as fixed or removable magnetic disk drive, an optical drive, solid state memory devices and other processor-readable storage media. Computer-executable instructions stored in the memory may include the query platform 440 having one or more program modules such as routines, programs, objects, components, data structures, and so on that perform particular tasks or implement particular abstract data types. For example, the memory may contain operating system (OS) component 595, modules and other components, database tables, and the like. These modules/components may be stored and accessed from the storage devices, including from external storage devices accessible through an interface bus.

The database components can store programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, stack, structured text file (e.g., XML), table, and/or the like. Such data-structures may be stored in memory and/or in structured files.

The controller 500 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the controller 500 may be distributed electronically over the Internet or over other networks (including wireless networks). Those skilled in the relevant art(s) will recognize that portions of the query system may reside on a server computer, while corresponding portions reside on a client computer. Data structures and transmission of data particular to aspects of the controller 500 are also encompassed within the scope of the disclosure.

Those skilled in the art will appreciate that the steps illustrated in each of the flow diagrams discussed above may be altered in a variety of ways. For example, the order of the logic may be rearranged, sub-steps may be performed in parallel, illustrated logic may be omitted, other logic may be included, etc.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives) and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, the word “or” refers to any possible permutation of a set of items. For example, the phrase “A, B, or C” refers to at least one of A, B, C, or any combination thereof, such as any of the following: A; B; C; A and B; A and C; B and C; A, B, and C; or multiples of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A computer-implemented method, comprising:
receiving a user input including one or more characters;
identifying a set of candidate classes for a target query based, at least in part, on the user input,
wherein each candidate class of the set of candidate classes is associated with a class hierarchy;
displaying at least a portion of the set of candidate classes in response to the receipt of the user input;
receiving a first user selection of a class from the set of candidate classes;
incorporating the selected class into the target query;
identifying a set of candidate query templates for the target query based on at least one of the user input, the selected class, or an attribute of the target query;
receiving a second user selection of a query template from the set of candidate query templates;
incorporating the selected query template into the target query; and
executing the target query including at least the selected class and the selected query template.

2. The method of claim 1, further comprising ranking the set of candidate query templates based, at least in part, on at least one of a class displayed, a query displayed, a previous user input, a previous user selection, a data source selected, or user profile information.

3. The method of claim 2, further comprising displaying at least a portion of the set of candidate query templates based, at least in part, on the ranking.

4. The method of claim 1, wherein the selected class and at least one other candidate class of the set of candidate classes are associated with a common class hierarchy.

5. The method of claim 1, wherein identifying the set of candidate query templates comprises matching the selected class with one or more candidate query templates.

6. The method of claim 5, wherein the matching is based, at least in part, on at least one of a relation of identity, a relation of information containment, or a relation of subsumption with one another.

7. A computer-implemented method, comprising:
receiving a first user input;
identifying a first set of candidate elements for a target query based, at least in part, on the first user input,
wherein the first set of candidate elements includes one or more classes, and
wherein each of the one or more classes is associated with a class hierarchy;
displaying at least a portion of the first set of candidate elements in response to the receipt of the first user input;
receiving a first user selection of a first class from the first set of candidate elements;
incorporating the first class as a first parameter of the target query;
identifying a second set of candidate elements for the target query based on at least one of the first user input, the selected first class, or an attribute of the target query;
receiving a second user selection of a second query element from the second set of candidate elements;
incorporating the second query element into the target query; and
executing the target query including at least the first class and/or the second query element.

8. The method of claim 7, wherein identifying the first set of candidate elements comprises matching the user input with at least one class in accordance with a position of the at least one class in an associated hierarchy.

9. The method of claim 7, wherein the second set of candidate elements includes one or more candidate query templates each having at least one query parameter.

10. The method of claim 7, further comprising changing the target query based, at least in part, on a second user input.

11. A non-transitory computer-readable medium storing computer-executable instructions that, when executed by one or more processors, cause the one or more processors to perform operations comprising:
identifying a first set of candidate elements for a target query based, at least in part, on a first user input,
wherein the first set of candidate elements includes at least one candidate class or candidate query;
displaying at least a portion of the first set of candidate elements in response to the first user input;
receiving a first user selection of a first element from the first set of candidate elements;
generating at least a portion of the target query based, at least in part, on the selected first element; and
executing the target query including at least the first element.

12. The non-transitory computer-readable medium of claim 11, wherein the candidate query comprises at least one modifiable placeholder.

13. The non-transitory computer-readable medium of claim 12, wherein the selected first element includes the candidate query.

14. The non-transitory computer-readable medium of claim 12, wherein the operations further comprise selecting at least a second element to be assigned to the at least one modifiable placeholder.

15. The non-transitory computer-readable medium of claim 14, wherein the second element includes a class.

16. The non-transitory computer-readable medium of claim 11, wherein the operations further comprise receiving the first user input via text or audio input.

17. The non-transitory computer-readable medium of claim 11, wherein the at least one candidate query is based, at least in part, on previously generated one or more queries.

18. A system comprising:
one or more processors;
a memory configured to store a set of instructions, which when executed by the one or more processors cause the one or more processors to:
identify a set of candidate elements for a target query based, at least in part, on a first linguistic input,
wherein the set of elements includes at least one candidate class or candidate query;
present at least a portion of the set of candidate elements in response to the first linguistic input;
receive a user selection of at least one element from the set of candidate elements;
generate at least a portion of the target query based, at least in part, on the selected at least one element;
modify at least a portion of the target query based, at least in part, on a second linguistic input; and
execute the modified target query including at least the at least one element selected from the set of candidate elements or an element based, at least in part, on the second linguistic input.

19. The system of claim 18, wherein the first linguistic input and the second linguistic input correspond to inputs from different users.

20. The system of claim 19, wherein the candidate class is associated with a family of classes having at least a relation of information containment or a relation of subsumption with one another.

21. The system of claim 18, wherein the candidate query includes one or more variables that can be modified based, at least in part, on user input.
